(19) United States
(12) Patent Application Publication
(10) Pub. No.: US 2020/0331083 A9
(43) Pub. Date: Oct. 22, 2020

(54) DOUBLE ONE-TRACK ELECTRO-DISCHARGE WIRE CUTTING METHOD

(71) Applicant: Beijing Dongxing Lubricant Limited Company, Beijing (CN)

(72) Inventors: Ci wen He, Beijing (CN); Jin Sheng Zhao, Beijing (CN)

(21) Appl. No.: 16/343,514

(22) PCT Filed: Jan. 9, 2018
(86) PCT No.: PCT/CN2018/071867

§ 371 Date: Apr. 19, 2019

(30) Foreign Application Priority Data
Feb. 8, 2017 (CN) 201710069565.9

(51) Int. Cl. B23H 7/10; B23H 7/02

(52) U.S. Cl. CPC B23H 7/10; B23H 7/02

(57) ABSTRACT

The present invention relates to a double one-track electro-discharge wire cutting method, comprising a step of forward wire running and a step of reverse wire running wherein a wire running direction of the step of forward wire running is opposite to that of the step of reverse wire running; with wire running in the step of forward wire running, one processing element is completed by discharge cutting processing, and with wire running in the step of reverse wire running, another processing element is completed by discharge cutting processing. The method can improve the processing efficiency and recycle the electrode wire while ensuring the processing precision.

### TECHNICAL FIELD

The present application relates to the technical field of electro-discharge wire cutting machining, and particularly to a double one-track electro-discharge wire cutting method.

### BACKGROUND OF THE INVENTION

The electro-discharge machining uses the pulse spark discharge to etch the material to be processed for processing. The processing electrode and the material to be processed are not in contact with each other due to a liquid dielectric medium therebetween. Therefore, a relatively soft electrode (tool) can be used to process a relatively hard and brittle conductive or semiconductor material, such as a metal. In the electro-discharge machining, it is widely used to make the wire electrode move for cutting processing. The wire electrode cutting is divided into two types: unidirectional wire running (slow wire running) and reciprocating wire running (fast wire running), wherein the reciprocating wire running wire cutting is a technology of electromechanical Integration having complete intellectual property, developed independently by China, and specifically owned by China. The advantages thereof includes that the apparatus is low in manufacturing cost, and the Mo alloy wire electrode (Mo wire) can be discharged for use repetitively for several times. It is especially suitable for processing materials high in hardness, strength, melting point, roughness or brittleness which are difficult to be handled by machining processing (such as Wo-Mo alloy, memory alloy, Mg alloy, hard alloy, polycrystalline diamond, NdFeB, etc.), and is widely used for mold making, aerospace, medical device, instrument, electronic appliances, mechanical manufacturing, and processing and manufacturing of precision or special-shaped components in various fields.

Currently, the electrode wire (generally being Cu wire) of the prior unidirectional wire running (slow wire running) wire cutting is disposable for use wherein the electrode wire is guided by the wire storing cylinder to the processing region for discharge only once and will be discarded after exiting the processing region, thus causing serious waste of the electrode wire, especially for small-energy cutting. The electrode wire of the reciprocating wire running (fast wire running) wire cutting can be reused for several times. However, both the two directions of the reciprocating wire running are used for discharge cutting, and the structure of the single wire cylinder makes limitation to the electrode wire length (generally only 200˜300 m) and thus causes a direction change for about every 20 seconds to form stripes due to frequent direction change, therefore, the processing precision thereof is much lower than that of the unidirectional wire running wire cutting.

The Chinese patent document CN105562854A discloses a unidirectional electro-discharge wire cutting method in which the electrode wire is recycled for use. The method comprises a step of forward wire running and a step of reverse wire running wherein a wire running direction of the step of forward wire running is opposite to that of the step of reverse wire running. With wire running in the step of forward wire running, the discharge cutting processing is performed, and with wire running in the step of reverse wire running, the discharge cutting processing is paused. The speed of the reverse wire running is higher than that of the forward wire running and is 10˜20 times of that of the forward wire running. In this method, as the discharge cutting processing is not performed during high speed reverse wire running, a waiting time of about 10% is produced due to direction change.

### SUMMARY OF THE INVENTION

In the present invention, in order to overcome the technical problem(s) in the prior art, a double one-track electro-discharge wire cutting method is provided which can improve the processing efficiency and recycle the electrode wire while ensuring the processing precision.

A double one-track electro-discharge wire cutting method comprises a step of forward wire running and a step of reverse wire running wherein a wire running direction of the step of forward wire running is opposite to that of the step of reverse wire running; with wire running in the step of forward wire running, one processing element is completed by discharge cutting processing, and with wire running in the step of reverse wire running, another processing element is completed by discharge cutting processing.

By discharge cutting in both the step of forward wire running and the step of reverse wire running and by changing the direction after completing cutting of one processing element, it can be ensured that during cutting of a single processing element, there will be no direction change for the electrode wire, and thus naturally no stripe due to direction change will be produced, thereby improving the processing precision. Also, there are advantages of the bidirectional wire running (i.e. the fast wire running) as in the prior art that the electrode wire can be recycled for use and the processing is fast, thus facilitating lowering the processing cost.

In a preferred technical solution, the additional technical feature is that the electrode wire has a diameter of 0.12˜0.18 mm.

The electrode wire with the above diameter has a high ability of electric current resistance, thus facilitating ensuring a continuous processing ability.

In a further preferred technical solution, the additional technical feature is that the electrode wire is a high-temperature alloy wire.

The selected high-temperature alloy wire facilitates improving the long-time processing ability of the electrode wire. Even if a relatively large processing face is to be processed, the processing precision and the surface finish will not be affected due to any problem of the electrode wire itself. The high-temperature alloy wire may be selected as a Wo-Mo alloy wire or a Mo alloy wire.

In a preferred technical solution, the additional technical feature is that the one processing element is one or more processing faces of one workpiece.

When the workpiece is relatively small, a certain wire running direction may be selected to process several processing faces or even all processing faces. This facilitates improving the uniformity for use of the electrode wire across the full length range, mitigating the problem of the electrode wire consuming fast due to over-frequent use in some portions but consuming slowly due to less frequent use in other portions, thereby improving the service life of the electrode wire.

In a preferred technical solution, the additional technical features are that in the discharge cutting processing, a power source is used which is a pulse power source, with a frequency of 0.032˜8 MHz.

In a preferred technical solution, the additional technical feature is that in the step of forward wire running, a wire running speed of 0.5˜12 m/s is used.

The present method is not only suitable for situations where the fast wire running is used in the prior art, but also suitable for situations where the slow wire running is used.

In a preferred technical solution, the additional technical feature is that in the step of reverse wire running, a wire running speed of 0.5˜12 m/s is used.

The present method is not only suitable for situations where the fast wire running is used in the prior art, but also suitable for situations where the slow wire running is used.

In a preferred technical solution, the additional technical features are that a reciprocating speed-variable wire moving mechanism with double wire running cylinders is used wherein each wire running cylinder can be winded with the electrode wire of a length of at least 5000 m.

By providing the electrode wire of a length of at least 5000 m, it can be suitable for most situations where a single processing face is processed by wire cutting processing, thus it can be ensured that during processing of one processing face, it is not necessary to replace the electrode wire.

In a further preferred technical solution, the additional technical feature is that in the discharge cutting processing, the wire running is performed with a constant tension.

By wire running with a constant tension, it is helpful to keep stable the motor speed for wire retraction, thus improving the processing precision.

In a further preferred technical solution, the additional technical features are that in the discharge cutting processing, a power source is used which is a pulse power source, with a frequency of 0.032˜8 MHz, and a wire cutting liquid to be used is a water-soluble wire cutting liquid matching the pulse power source.

By using the water-soluble wire cutting liquid as the discharge medium, it can be used for a long time without drainage (or with little drainage), is pollution-less, non-toxic and harmless to the working environment and nature, and is non-irritating to the human body.

### DESCRIPTION OF THE DRAWINGS

FIG. 1 is a structural diagram of a reciprocating speed-variable wire moving system with double wire cylinders as used in Embodiment 1 of the present utility model.

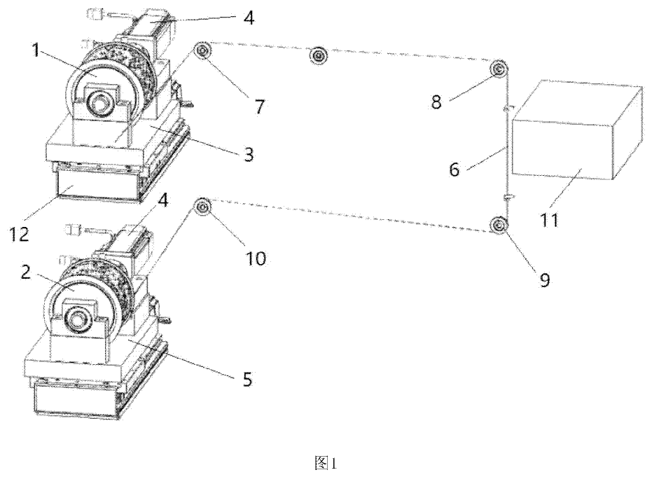

### DESCRIPTION OF EXEMPLARY EMBODIMENTS

In order to further understand the content, features and effects of the present invention, the embodiments are set forth hereinafter and will be described in detail as follows.

### Embodiment 1

A double one-track electro-discharge wire cutting method comprises a step of forward wire running and a step of reverse wire running wherein a wire running direction of the step of forward wire running is opposite to that of the step of reverse wire running; with wire running in the step of forward wire running, one processing element is completed by discharge cutting processing, and with wire running in the step of reverse wire running, another processing element is completed by discharge cutting processing.

By discharge cutting in both the step of forward wire running and the step of reverse wire running and by changing the direction after completing cutting of one processing element, it can be ensured that during cutting of a single processing element, there will be no direction change for the electrode wire, and thus naturally no stripe due to direction change will be produced, thereby improving the processing precision. Also, there are advantages of the bidirectional wire running (i.e. the fast wire running) as in the prior art that the electrode wire can be recycled for use and the processing is fast, thus facilitating lowering the processing cost.

Preferably, the electrode wire has a diameter of 0.12˜0.18 mm.

The electrode wire with the above diameter has a high ability of electric current resistance, thus facilitating ensuring a continuous processing ability.

Further preferably, the electrode wire is a high-temperature alloy wire.

The selected high-temperature alloy wire facilitates improving the long-time processing ability of the electrode wire. Even if a relatively large processing face is to be processed, the processing precision and the surface finish will not be affected due to any problem of the electrode wire itself. The high-temperature alloy wire may be selected as a Wo-Mo alloy wire or a Mo alloy wire.

Preferably, the one processing element is one or more processing faces of one workpiece.

When the workpiece is relatively small, a certain wire running direction may be selected to process several processing faces or even all processing faces. This facilitates improving the uniformity for use of the electrode wire across the full length range, mitigating the problem of the electrode wire consuming fast due to over-frequent use in some portions but consuming slowly due to less frequent use in other portions, thereby improving the service life of the electrode wire.

Preferably, in the discharge cutting processing, a power source is used which is a pulse power source, with a frequency of 0.032˜8 MHz.

Preferably, in the step of forward wire running, a wire running speed of 0.5˜12 m/s is used.

The present method is not only suitable for situations where the fast wire running is used in the prior art, but also suitable for situations where the slow wire running is used.

Preferably, in the step of reverse wire running, a wire running speed of 0.5˜12 m/s is used.

The present method is not only suitable for situations where the fast wire running is used in the prior art, but also suitable for situations where the slow wire running is used.

Preferably, a reciprocating speed-variable wire moving mechanism with double wire running cylinders is used wherein each wire running cylinder is able to be winded with the electrode wire of a length of at least 5000 m.

By providing the electrode wire of a length of at least 5000 m, it can be suitable for most situations where a single processing face is processed by wire cutting processing, thus it can be ensured that during processing of one processing face, it is not necessary to replace the electrode wire.

Further preferably, in the discharge cutting processing, the wire running is performed with a constant tension.

By wire running with a constant tension, it is helpful to keep stable the motor speed for wire retraction, thus improving the processing precision.

Furthermore, preferably, in the discharge cutting processing, a power source is used which is a pulse power source, with a frequency of 0.032˜8 MHz, and a wire cutting liquid to be used is a water-soluble wire cutting liquid matching the pulse power source.

By using the water-soluble wire cutting liquid as the discharge medium, it can be used for a long time without drainage (or with little drainage), is pollution-less, non-toxic and harmless to the working environment and nature, and is non-irritating to the human body.

Specifically, based on the prior fast wire running wire cutting machine, a high-frequency nanosecond pulse power source with a frequency of 4 MHz is used and an 8-cylinder-type electrode wire holder is added and assembled, and a speed-variable reciprocating wire moving system with double wire cylinders is added and assembled. The wire cutting is performed in the water-soluble discharge composition as described in the Chinese patent document CN101161797B, and the workpiece of Cr12 die steel having a thickness of 40 mm is cut. A Mo wire having a diameter of 0.18 mm is used for the electrode. The forward wire running speed is 1 m/s and the reverse wire running speed is 1 m/s. A tetragonal prism body of 10×10 mm is processed by cutting. The surface roughness Ra is 0.008˜0.009 mm. There is no direction change stripe on the processed surface. The surface quality by the process of one step of cutting can achieve the effect of three repetitive processes, including one step of cutting plus two steps of finishing, by the “middle speed wire running” machine.

Specifically, the speed-variable reciprocating wire moving system with double wire cylinders comprises a forward wire running cylinder 1 and a reverse wire running cylinder 4. The forward wire running cylinder 1 and the reverse wire running cylinder 4 are in driving connection with a speed-variable winding motor 2, respectively. The forward wire running cylinder 1 and the reverse wire running cylinder 4 are used to pull one electrode wire 6.

By pulling the electrode wire 6 in two directions by the forward wire running cylinder 1 and the reverse wire running cylinder 4, respectively, on each wire running cylinder, there is only one region for the electrode wire 6 to be received or released where the electrode wires 6 can be winded layer by layer without getting disordered. Therefore, the number of the electrode wires 6 stored on the wire running cylinder can be significantly increased. Thus, the single cutting element can be cut by the same one electrode wire 6 continuously, and another cutting element can be cut in another wire running direction.

Preferably, the speed-variable winding motor 2 is a servo motor.

The servo motor is precise in transmission, and can be used when the electrode wire 6 is winded layer by layer or its winding radius varies, thus ensuring that the electrode wire 6 has a stable wire running speed and improving the processing precision.

Preferably, a wire guiding wheel is provided between the forward wire running cylinder 1 and the reverse wire running cylinder 4.

By the wire guiding wheel, the electrode wire 6 is stable in the position and direction to enter and exit the cutting region, reducing the motor system shaking during wire running and thus improving the processing precision.

More preferably, the wire guiding wheel, the forward wire running cylinder 1 and the reverse wire running cylinder 4 are arranged such that the electrode wires 6 between the forward wire running cylinder 1 and the reverse wire running cylinder 4 are within the same plane. Specifically, four wire guiding wheels may be provided wherein the first wire guiding wheel is provided on the forward wire running cylinder 1 in a position for releasing wire, the second and third wire guiding wheels may be provided in the vertical direction as shown in the figures, and the fourth wire guiding wheel may be provided on the reverse wire running cylinder 4 in the position for retracting wire. The four wire guiding wheels are within the same plane.

By arranging the wire guiding wheels within the same plane, any twisting of the electrode wire 6 during wire running can be reduced as far as possible to extend the service life of the electrode wire 6.

Preferably, the forward wire running cylinder 1 is rotatably mounted on the first pulling plate 3 which is mounted thereon with the speed-variable winding motor 2 connected to the forward wire running cylinder 1. The reverse wire running cylinder 4 is rotatably mounted on the second pulling plate 5 which is mounted thereon with the speed-variable winding motor 2 connected to the reverse wire running cylinder 4. The first pulling plate 3 and the second pulling plate 5 are in transmission connection with the respective pulling plate driving devices and are connected via the linear guide(s) onto the base seat 12.

As the wire running cylinders are different in the instant winding radius, the speed-variable winding motors 2 for the two wire running cylinders are different in the rotation speed. Therefore, each pulling plate for mounting the wire running cylinder is driven individually. It is possible to make the wire exiting point and the wire entering point of the wire running cylinder on each pulling plate precisely match the running plane of the electrode wire 6, thus ensuring the stability of the length and tension degree of the electrode wire 6, thereby facilitating improving the processing precision.

More preferably, the first pulling plate 3 and the second pulling plate 5 are connected via the roller screw mechanism(s) with the pulling plate driving motor(s).

The roller screw mechanism is high in transmission precision and can precisely control the axial position of the pulling plate moved, thus facilitating reducing the change in length of the electrode wire 6 during wire running.

Further more preferably, the pulling plate driving motor is a servo motor.

The servo motor is precise in transmission and can precisely control the axial position of the pulling plate moved, thus facilitating reducing the change in length of the electrode wire 6 during wire running.

Preferably, in the forward wire running cylinder 1 and the reverse wire running cylinder 4, one is used for releasing wire with a constant torque and the other is used for retracting wire with a constant rotation speed.

By retracting wire with a constant rotation speed, the running speed of the electrode wire 6 can be stabilized, and by releasing wire with a constant torque, a relatively stable load moment can be provided for retracting wire, thus ensuring a stable speed of retracting wire.

Preferably, each of the forward wire running cylinder 1 and the reverse wire running cylinder 4 is precisely and compactly winded thereon layer by layer with the electrode wire(s) 6. It is to be explained that the “precisely and compactly” in the “precisely and compactly winded thereon layer by layer” should not be understood as a modifier generally to long/short, thick/thin, or the like. The “precisely and compactly winded thereon layer by layer” means that the strip materials or wire materials winded on the wheel or cylinder is compactly arranged at the same layer height. Therefore, the next outer layer of strip materials or wire materials can be considered as being winded on the inner layer of strip materials or wire materials. It will not become disordered between various layers of strip materials or wire materials. Therefore, such expression is clear.

By the manner of precise and compact winding layer by layer, it can be ensured that the instant winding radius at the wire retracting point or the wire releasing point is reliable, by means of the retracted electrode wire 6 or the unreleased electrode wire 6, thus ensuring a precise and reliable speed of wire releasing or wire retracting.

### Embodiment 2

The present embodiment differs from Embodiment 1 in that the workpiece of Cr12 die steel having a thickness of 60 mm is cut. A Mo wire having a diameter of 0.18 mm is used for the electrode. The forward wire running speed is 4 m/s and the reverse wire running speed is 4 m/s. A tetragonal prism body of 10×10 mm is processed by cutting. There is no direction change stripe on the processed surface. The surface quality by the process of one step of cutting can achieve the effect of two repetitive processes, including one step of cutting plus one step of finishing, by the “middle speed wire running” machine.

### Embodiment 3

The present embodiment differs from Embodiment 2 in that the forward wire running speed is 11 m/s and the reverse wire running speed is 11 m/s. A tetragonal prism body of 10×10 mm is processed by cutting. There is no direction change stripe on the processed surface. The surface roughness Ra can be 0.9 μm. The precision by the process of one step of cutting is higher by one level than that by the prior reciprocating wire running (fast wire running) wire cutting.

The preferred embodiments of the present invention have been described as above in combination with the accompanying drawings. However, the present invention is not limited to the above specific implementations. The above specific implementations are only for illustration, rather than limiting the present invention. Those skilled in the art, with the teaching of the present invention, can make various forms of modification thereto, without departing from the gist of the present invention and the protection scope of the claims. These modification forms will be within the protection scope of the present invention.

1. A double one-track electro-discharge wire cutting method, characterized in that it comprises a step of forward wire running and a step of reverse wire running wherein a wire running direction of the step of forward wire running is opposite to that of the step of reverse wire running; with wire running in the step of forward wire running, one processing element is completed by discharge cutting processing, and with wire running in the step of reverse wire running, another processing element is completed by discharge cutting processing.

2. The double one-track electro-discharge wire cutting method according to claim 1, characterized in that the electrode wire has a diameter of 0.12˜0.18 mm.

3. The double one-track electro-discharge wire cutting method according to claim 1, characterized in that the electrode wire is a high-temperature alloy wire.

4. The double one-track electro-discharge wire cutting method according to claim 1, characterized in that the one processing element is one or more processing faces of one workpiece.

5. The double one-track electro-discharge wire cutting method according to claim 1, characterized in that in the discharge cutting processing, a power source is used which is a pulse power source, with a frequency of 0.032˜8 MHz.

6. The double one-track electro-discharge wire cutting method according to claim 1, characterized in that in the step of forward wire running, a wire running speed of 0.5˜12 m/s is used.

7. The double one-track electro-discharge wire cutting method according to claim 1, characterized in that in the step of reverse wire running, a wire running speed of 0.5˜12 m/s is used.

8. The double one-track electro-discharge wire cutting method according to claim 1, characterized in that a reciprocating speed-variable wire moving mechanism with double wire running cylinders is used wherein each wire running cylinder can be winded with the electrode wire of a length of at least 5000 m.

9. The double one-track electro-discharge wire cutting method according to claim 8, characterized in that in the discharge cutting processing, the wire running is performed with a constant tension.

10. The double one-track electro-discharge wire cutting method according to claim 8, characterized in that in the discharge cutting processing, a power source is used which is a pulse power source, with a frequency of 0.032˜8 MHz, and a wire cutting liquid to be used is a water-soluble wire cutting liquid matching the pulse power source.

11. The double one-track electro-discharge wire cutting method according to claim 2, characterized in that the electrode wire is a high-temperature alloy wire.

12. The double one-track electro-discharge wire cutting method according to claim 9, characterized in that in the discharge cutting processing, a power source is used which is a pulse power source, with a frequency of 0.032˜8 MHz, and a wire cutting liquid to be used is a water-soluble wire cutting liquid matching the pulse power source.
